(19) United States
(12) Patent Application Publication
(10) Pub. No.: US 2025/0337623 A1
(43) Pub. Date: Oct. 30, 2025

(54) Digital Carrier Transmitter for High-Speed Radio

(71) Applicant: Marvin Motsenbocker, Kamijima (JP)

(72) Inventor: Marvin Motsenbocker, Kamijima (JP)

(21) Appl. No.: 19/183,872

(22) Filed: Apr. 20, 2025

Related U.S. Application Data
(60) Provisional application No. 63/638,444, filed on Apr. 25, 2024.
(60) Provisional application No. 63/640,237, filed on Apr. 30, 2024.

(51) Int. Cl. H04L 27/26

(52) U.S. Cl. CPC H04L 27/2602; H04L 27/2626

(57) ABSTRACT

A non-resonance alternative to modulated carrier wave radio provides narrowband, 1 mbit per second digital radio communication in the short wave bands and faster communication at higher frequencies. Modulated carrier techniques such as AM, FM, PSK, and ASK are limited by resonation and hysteresis transients, which distort the leading cycles and ending cycles in a communication wave train, causing delays. This necessitates a long wave train to encode each signal change. These limitations were minimized by removing resonance from the transmission signal path, and by using zero signal crossing for transmission and receiver detection. The transmitter has multiple class A amplifier stages connected directly to a non-resonant antenna. The digital carrier transmitter provides high data rates by eschewing modulation and resonance circuitry.

### CROSS-REFERENCE TO RELATED APPLICATIONS

This application receives priority from U.S. Pat. No. 63,638,444 filed Apr. 25, 2024 entitled Resonance Free Radio Transmitter for High-Speed Communications, and U.S. Pat. No. 63,640,237 filed Apr. 30, 2024 entitled Controlled Resonance Radio Reception of Photon Pulses the contents of which are incorporated by reference.

### BACKGROUND OF THE INVENTION

Modern communications encode and decode signals by modulating and demodulating carrier waves. This basic technique was an important advance over the spark transmitter design from 120 years ago. Now, carrier modulation is used for everything, from commercial broadcasts, satellite transmissions, the physical layer of the internet, and even SETI (search for extra-terrestrial intelligence). These communication modes require many repeating waves to encode even the smallest bit of information.

Unfortunately, the use of carrier modulation to embed information into sidebands limits communication speed. For example, amplitude shift keying (“ASK”) turns a carrier wave on and off (or up and down). This digital control is strictly limited by the creation of sidebands and is used for slow speed digital communications. ASK has “very poor bandwidth efficiency” and “is not fit for high bit rate data transmission” due to these complications as mentioned in the art. See for example https://www.watelectronics.com/what-is-an-amplitude-shift-keying-working-and-applications/.

These communication techniques do not manipulate electromagnetic energy as discrete photon groups but are grounded on pre-quantum physics technology of wave action. Thus, radio transmitters generate repeating identical waves upon which a signal is impressed via modulation. In fact, radio energy is synonymous with “radio wave” in our lexicon.

This focus on waves is reinforced by the ubiquitous use of the Fourier transform, which requires multiple waves to encode and decode each bit of information. Fourier transform theory teaches that as the number of modulated waves in a wave train decreases, the signal bandwidth increases. As the wave train approaches one wavelength long, the electromagnetic signal blows up into infinite bandwidth, and thus cannot be used for communication.

Long wave trains have their limitations. Early pioneers of radio technology invented frequency filters to select and purify their signals from their newly discovered long resonance-derived wave trains. They discovered that in the process of filtering their waves with tuning circuits, the filters generated transients and mangled the first and last waves of every modulation change (signal) in a wave train. This signal degradation occurs because resonant devices such as filters temporarily store energy from each wave of a signal. The stored energy from each wave is returned back to the circuit from the filter at a later time. Thus, the filter must ring up and ring down into and out of steady state when responding to information in a change of a signal and delay the communication. The first and last waves of every change in modulation of a signal wave train thereby become useless.

### Transient Responses of Filters Used in Radio Cause Signal Broadening and Delay

The transient distortion problem of resonance was acknowledged by early radio inventors. A. J. Starr, a research engineer at Marconi's Wireless Telegraphy in the 1930s explained this in his textbook Electric Circuits and Wave Filters published by Sir Isaac Pitman & Sons, Ltd. 1934, 1938. He pointed out that “[f]ilter properties are completely lost in transient conditions.” Furthermore, these transient conditions can last some time as “many cycles come through (the filter) before the current dies down to the very small steady-state value.” (pages 352-353)

D. G. Tucker in 1946 summarized two “rules of thumb” on this topic in his book “Transient Response of Filters.” One, “[t]he build-up time of a band-pass filter for an applied signal of mid-band frequency is equal to the reciprocal of the bandwidth in cycles/sec. For a low-pass filter, the build-up time of an applied D. C. signal is one-half of the reciprocal of the cut-off frequency in cycles/sec.” and two “[t]he amplitude of the peak of the transient caused by the sudden application or removal of a frequency outside the pass-band of a band-pass filter is proportional to the bandwidth and inversely proportional to the difference between applied frequency and mid-band frequency.”

A variety of invented resonant filters tradeoff frequency discrimination with smoothness of response to signal transients. FIG. 1, compares the responses of 3 popular filters, Bessel 10, Butterworth 20, and Chebyshev 30. The responses shown in this figure are normalized for a frequency cutoff of 1 Hz in X-axis 40. In comparing these three filters in the second plot, you can see that the signal discrimination (filter power) improves as the transient behavior gets progressively poorer. The sharpest filter Chebyshev 30 causes the greatest delay (plot 31) wherein progressively less steep filters delay less (plot 21 and plot 11) as shown in the lower graph. These prior art graphs show how all filters absorb and later remit, with some smearing, at a later time, energy from signal changes that pass through them. Filters necessarily require extra leading and trailing ends of wave segments for each modulation event of a communication. And, “[a]ll filters have time delay, a truth that cannot be avoided.” Experimental Methods in RF Design page 3.32 published 2012 by the American Radio Relay League.

Even so called “pulse” communications such as “chirps,” used in satellite transmissions are actually wave trains of many cycles having distorted beginning and ending regions. See FIG. 2, which shows a time response of a “pulse” transmission 210 used for satellites. This is often referred to as a “chirp” because many photon cycles are assembled in time sequence and with varying frequencies, which increases bandwidth. The “pulse” bandwidth 220 in this example is about 15 MHz. The concept of radio communication “pulse” comprising only 1 or a few sine waves of energy is generally unfamiliar to practitioners.

Carrier modulation techniques exploit wave theory wherein a signal frequency is mixed and heterodyned with a “carrier” wave train to create another wave train. This creates two sidebands of multiple frequencies that encode the signal information. The carrier often is removed, as well as one of the redundant sidebands. Unfortunately, the sidebands occupy progressively wider frequency bandwidth as more information is added to the transmission.

The 100 year old heterodyne technique based on wave theory does not take advantage of a quantum physics perspective, which considers individual photons. In fact, many practitioners do not even believe that radio communications involve photons.

### SUMMARY OF THE INVENTION

An embodiment provides a digital carrier transmitter comprising a frequency generator, an input that accepts a digital message to transmit, a non-resonant antenna, and a circuit connected to the frequency generator that receives the digital message from the input, generates individual sine wave pulses having one or more sine wave lengths with sine wavelength determined from the frequency generator, and outputs sine wave pulses to the antenna in a direct current.

An embodiment provides a direct current radio transmitter that transmits each data bit as less than 20 sine wave long duration discrete pauses, or pulses of electromagnetic energy, comprising a radio signal generator having a frequency output, a non-resonant antenna; and a circuit that accepts the frequency output and generates discrete integer length wavelength portions or discrete half integer length wavelength portions of the wavelength of the radio signal reference as direct current to the non-resonant antenna.

### BRIEF DESCRIPTION OF DRAWINGS

FIG. 1 is a graphical comparison of 3 prior art filters.

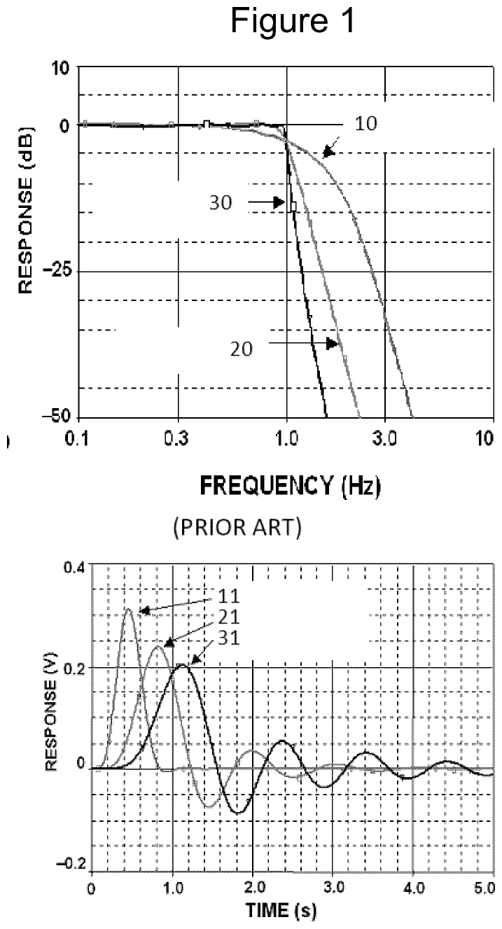

FIG. 2 is an envelope shape of a typical pulse transmission.

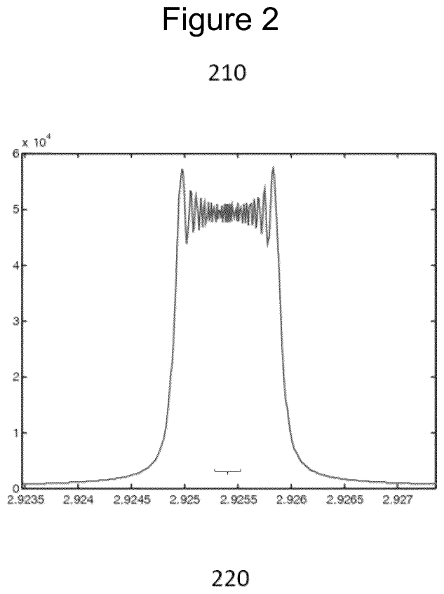

FIG. 3 is a block diagram of a digital carrier embodiment.

FIG. 4 is a schematic of a digital carrier embodiment.

FIG. 5 is an outline of a communication system using a digital carrier embodiment.

FIG. 6 shows a transmitted pulse and received pulse from a 4 MHZ communication system.

FIG. 7 shows a transmitted pulse and a received pulse from a 10 MHz communication system.

FIG. 8 is a block diagram of an embodiment for a transmitter.

FIG. 9 is a schematic embodiment of a harmonic removal circuit.

FIG. 10 shows two block diagrams of sideband removal embodiments.

FIG. 11 is a schematic embodiment of a sideband removal embodiment.

FIG. 12 shows data obtained from a sideband removal embodiment.

FIG. 13 shows an embodiment for removing sidebands.

### DETAILED DESCRIPTION OF THE INVENTION

A digital carrier transmitter can generate individual single sine(s) one wave length long each, or half sine pulses of photons instead of waves. The transmitter can group one or more of the photon pulse sines into a transmitted digital signal. For example, a single photon duration (i.e. one sine wave long) pulse output from a 10-watt transmitter operating on 10 MHz (the 30 meter wavelength band) contains about 1.5×1020 identical photons within the 100 ns time of a single wavelength. Each pulse of 1.5×1020 photons ideally could be sensed by a receiver as a single bit of digital information.

Ideally, an antenna far away would intercept enough of these 10 MHz (30 meter long) photons to generate a one wavelength (100 ns) long bit pulse in a receiver. This was demonstrated by energizing metallic bond valence electrons at an antenna surface using a direct current pulse corresponding to a partial or full-size wave. An oscilloscope positioned 3.5 wavelengths away and attached to a non-resonant beverage antenna detected enough of these photons to form a strong 15 mV pulse without any filtering. See https://vixra.org/abs/2310.0123.

Unfortunately, receivers do not exist that conveniently detect a single sine wave long pulse as a single bit of information. Without wishing to be bound by any one theory for how this works, it is believed that resonant devices such as filters and impedance matchers absorb each pulse and re-emit the absorbed energy later in time via collapsing the wave function. The absorbed energy (from collapse) is released as virtually the same wave function but at integers of wave time later. This complicates the separation of individual photon pulses.

Thus, each frequency filter in the radio mangles the beginning and ending portions of a modulation change. However, by carefully selecting a minimum amount of resonance, a compromise hybrid radio can be built that minimizes resonance yet detects bit signals as short as 3, 5 or 10 cycles long. Preferably added resonance is at or near to a critical resonance of the resonator, to prevent ringing and minimize disturbance to the signal. Preferably a resonator such as a crystal, inductor-capacitor combination, or surface acoustic wave filter is configured for critical resonance by adding resistance. In an embodiment, “at or near critical resonance” means a Q factor of between 0.1 and 10 and more preferably between 0.25 and 1. Preferably resistance is added in series with a crystal or an inductor of an inductor-capacitor pair that prevents ringing and excessive resonance.

In the case of an LC resonator the reactance in ohms for the selected frequency can be calculated. The resistor added in series should be within 5 fold of this value, preferably within 2 fold and preferably not less than this value. The reactance of a given crystal resonator for a given frequency may be difficult to calculate or measure, but for a typical AT cut crystal, the added resistance preferably is between 100 and 1000 ohms. Most preferably this resistance is varied by a circuit that responds to the need for adding a minimum amount of crystal resonance to remove a carrier signal component.

In an embodiment the digital carrier transmitter and a receiver that can sense the pulses operate on sequential photon train segments equal to or less than 3 photon sine waves long. In another embodiment the photon train is less than 6 sine waves long and in another embodiment the photon train is less than 11 sine waves long or set to a number between 10 and 100. It is best if a tuning circuit used to sense the sequential photon train has adjustable dampening and can adjust a variable resistance.

As an example, a digital carrier 4 megahertz transmission of 5 cycles (i.e. a string length of 5 continuous sine lengths per bit) allows communication of up to 800 kilobits per second at this low frequency. A 10 megahertz transmission of 10 cycles per bit can likewise accommodate 1 megabit per second. By making each bit occupy multiple cycles as in these examples, one can operate a traditional tuning circuit near or at critical resonance, while sacrificing the beginning and end parts of each bit signal.

One consideration is to monitor the relationship between bit size and strength of the tuning or filter circuit to provide just enough selectivity to get a readable signal. In an embodiment, the degree of resonance is sensed and controls a signal output that corresponds in strength or other quality, such as phase, in response to the amount of ringing, or resonance energy in a circuit. The output signal triggers a resonance adjuster to increase resistance in a resonance filter. In response to a higher resonance or ringing level, this feedback circuit decreases resonance by for example adding resistance to a resonation device such as an LC (inductor plus capacitor of equal impedance at a desired filter resonance frequency) filter or crystal. For example, a JFET with its source and drain interposed in series with an inductor or crystal can be activated to increase resistance in response to a signal in response to increased resonation. By increasing resistance, the JFET increases dampening of the filter resonator and lowers the resonance.

### Digital Carrier Transmitter Circuit

A novel digital carrier transmitter was discovered that can transmit small multiples of sequential sine time periods of photons. Groups of 5, 10, 50 or 100 cycles long bits were transmitted at frequencies up to 10 megahertz. This transmitter includes a 128 bit shift register, which the user manually can program to repeatedly transmit a message up to 128 bits long. Higher frequencies can be handled by selecting faster chips. The shift register and the divide by 10 counter chip used were limited in response to about 10 MHz.

No transmission line was used. A non-resonant antenna was directly attached to the output of the final stage of the non-resonant transmitter. The resistance of the antenna was tuned to eliminate a small amount of residual resonance. For both beverage and “TEFV” (terminated end fed vertical) antennas, this was about 300 ohms. Non-resonant antennas are high impedance, typically 250-400 ohms, which is perhaps not coincidentally similar to the 377 ohm natural impedance of free space. In contrast, a 50 ohm transmitter/antenna system accepts a lower voltage, lower impedance input and resonates to a higher voltage during operation. Thus, a transmitter that matches a high impedance (>70 ohm) antenna directly without benefit of voltage changing resonance must have a higher voltage output stage to transfer the same power.

A high voltage MOSFET was chosen for the output stage of the transmitter. Finally, for more complete removal of resonance, linear amplification was carried out. The circuit used an analog switch to select desired portions of the reference signal train with a square wave. By turning on the switch that controls passage of the sine wave train, different time length square waves selected a desired signal duration (number of sine waves in the signal train) and timing. The selected portion was amplified by the linear amplifier stages without resonance coupling between stages.

### A Digital Carrier Transmitter for Short Pulse Trains

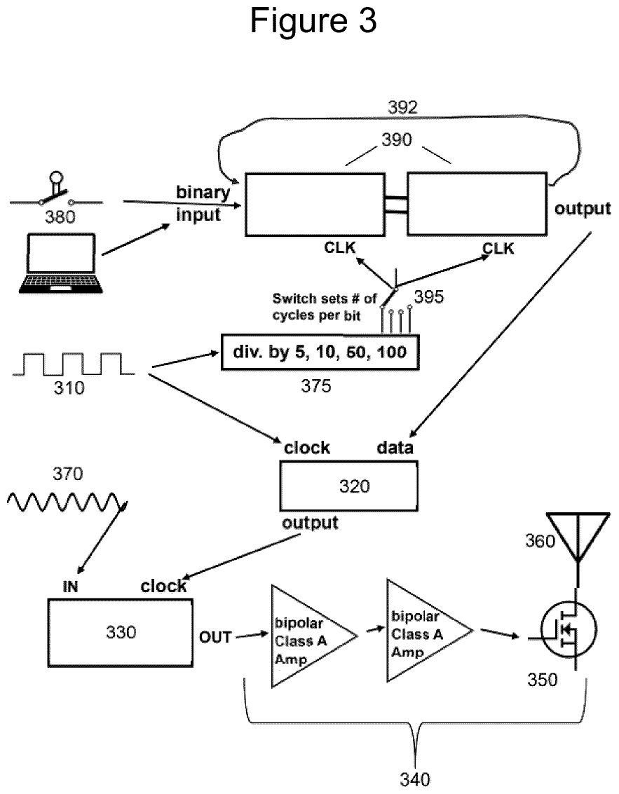

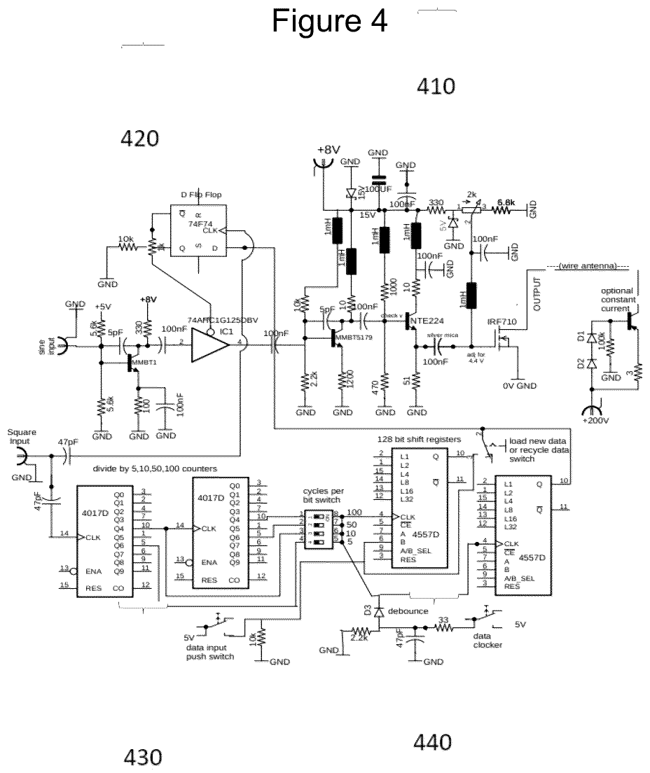

An embodiment of the non-resonant digital carrier transmitter comprises a sine wave oscillator input and a synchronous square wave input. See the block diagram of FIG. 3 and the schematic of FIG. 4. The square wave input 310 from a frequency generator triggers fast D flip flop 320, which has an output that switches fast analog switch 330 at zero crossing, and thus allows selection of complete, distinct sine waves. The selected sine waves from switch 330 are fed to 3 transistor linear amplifier 340. The output stage of amplifier 340 comprises high voltage MOSFET 350 with its drain output pin directly connected to non-resonant antenna 360. The antenna/MOSFET in series with a 300-volt power supply (not shown) presented a direct current circuitous route for electron energy that moves in only one direction through the antenna. A version of this circuit, which was used to discover direct current generation of radio waves for single photon pulse detection, was described previously in US No. 63/530,982, filed Aug. 6, 2023 with the title “Digital Radio.” The entire contents of this previously filed patent application and particularly the circuits, drawings and concepts related to radio, are hereby incorporated by reference.

The signal generator also provided synchronized sine wave 370 shown in FIG. 3 at approximately 1 volt at 50 ohms. The square wave 310, which is in sync with the sine wave, triggers flip flop 320, which outputs changes to data at the zero-crossing point by turning on and off fast analog switch 330 at the appropriate time. A separate square wave was convenient here because the phase and duty cycle were easily adjusted to compensate for small timing delays from wiring inductances, transistor switching times etc.

Square wave 310 also triggers a divide by 5, 10, 50 and 100 counter 375 as well as triggering D-flip flop 320 at zero crossing of the sine wave. The flip flop 320 is triggered at 5, 10, 50 or 100 times lower frequency than the reference frequency, which allows 5, 10, 50 or 100 sine length pulses to enter amplifier chain 340. A preferred embodiment includes one oscillator as a signal reference and prepares synchronized square and sine waves from that.

The amplifier chain 340 in this embodiment comprises class A biased transistors. The first two transistors were bipolar, low impedance types in voltage follower configuration and provided a large amplified current to the gate of high voltage MOSFET 350. The drain of MOSFET 350 connects directly to non-resonant antenna 360 and is driven by a 300 volt DC power supply (not shown). No inductor or resonance filter was used in the signal path to minimize resonance deterioration of the signal pulse.

D flip flop 320 acts as a latch for incoming data. In the example shown here, a data input device 380 such as keyer or computer output is input to the shift register 390. Shift register 390 is clocked by time base divider 375, which determines how many sine wave cycles are allowed in each data bit. In this way, a morse code keyer or other data stream can be input at speeds much slower than the square wave. The keyer, computer, or other memory device thus can control how many integral sines to transmit in each data bit. A switchable endless loop option 392 allows the data to recycle.

FIG. 4 shows a circuit diagram for an embodiment. Upper right hand portion 410 is the amplifier chain. Upper left hand portion 420 comprises the flip flop and analog switch. Lower left portion 430 shows the time dividers that determine the bit speed. Lower right portion 440 shows connections for the shift register. Preferably a shift register or other data buffer is interfaced to a computer via a serial or parallel interface.

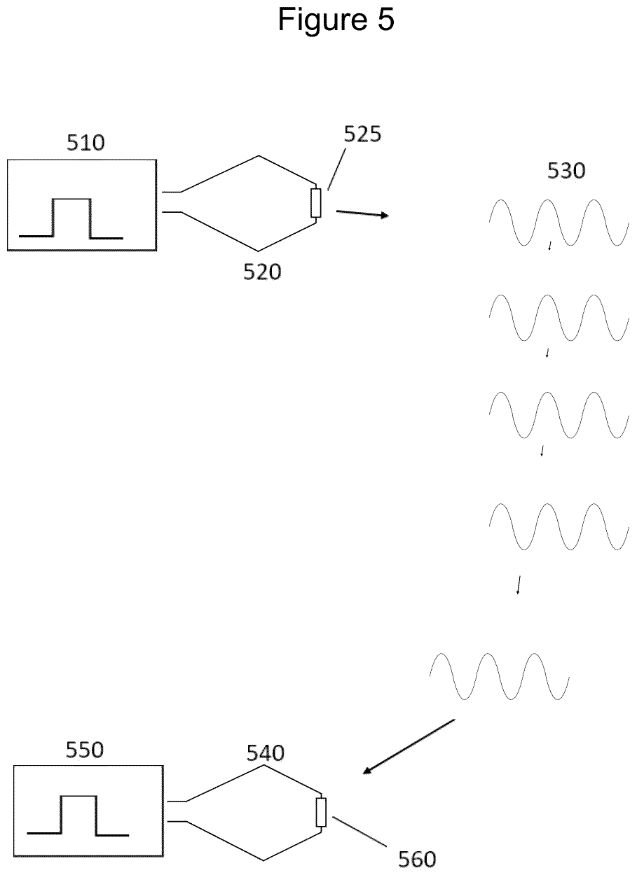

The transmitter embodiment shown in FIGS. 3 and 4 was used in the communication system shown in FIG. 5. FIG. 5 shows, at upper left, transmitter 510, which is direct current coupled (i.e. without a coupling capacitor) to non-resonant antenna 520. Antenna 520 may have termination resistor 525, to limit reflections in the antenna.

Signals from this transmitter preferably are emitted off the long axis of the non-resonant antenna 520 towards the termination resistor 525 end as depicted in FIG. 5.

Each bit of the communication signal in this embodiment comprises 3 sines as shown by waveform 530. The 3 sine energy travels towards another non-resonant antenna 540, which is connected to receiver 550. Many non-resonance type antennas have termination resistor 560 located on the end of the long axis of such antenna. When using this embodiment, preferably the resistor has a resistance of between 100 and 2000 ohms and more preferably 200 to 500 ohms.

In a high frequency embodiment of more than 500 MHz the transmitter preferably is connected to a non-resonant rhombic antenna.

Receiver 550 accepts signal energy from the antenna, which preferably is in the form of an induced electric sine shaped pulse containing each of the 3 sines of the originally transmitted signal. In an embodiment half sine signals are generated and received. In yet another embodiment positive going half sines are mixed with negative going half sines to form a communication data stream of ones and zeros, represented by the two alternating forms. In the embodiment of FIG. 5, multiple sines such as the 3 shown here, which represent a bit are detected as a single pulse via an appropriate circuit. For example, an AC to DC radio frequency circuit with fast diodes can rectify a multi-sine pulse into a suitable length direct current pulse, with the choice of a suitable RC time constant for the components.

### Non-Resonant Direct Current Energy Presented to an Antenna Load

The transmitter described in FIGS. 3 and 4 was used at 2-28 MHz with a terminated end fed vee antenna (TEFV) as the non-resonant antenna for both transmitter and receiver. Each TEFV was 40 meters long with a maximum height of 10 meters and constructed as described in https://vu3dxr.in/diy-terminated-end-fed-vee-antenna-tefv/.

Initial transmissions were carried out with an oscilloscope attached to the receiving antenna. For later experiments with multiple photon sine wave transmissions, a single tuned circuit and a double tuned circuit receiver were constructed and attached directly to the non-resonant receiver antenna.

### Example 1 Transmission of Short Multi Sine Length Photon Pulse Trains

Initial experiments (reported at https://vixra.org/abs/2310.0123 “Direct Current Generation of Radio Wave Photons from an Antenna”) were carried out with a version of the transmitter that transmitted only separate one sine wave long pulses as bits. In that study an oscilloscope was used to detect one-photon long pulses from the transmitter without regard to sidebands. This was impractical.

In order to develop and test a more practical system, a compromise transmitter of short repeated sines was made to allow limited resonance in a more flexible receiver. The resonant filter added to the receiver separated the transmitted signal from background signals but destroyed single sine wave signals.

The compromise system described here comprises a transmitter that transmits (for example) 5, 10, 50 or 100 contiguous photon sine wave pulses. In this way the receiver can include a small amount of resonance to filter transmitted signals and sacrifice one or a few photon sine cycles per bit. For example, 5 photon cycle long bits were created in a 4 MHz (75 meters) frequency at speeds of up to 800 kbits per second.

The receiver was a compromise hybrid of an “LC” (inductor capacitor resonating pair) legacy resonance filter combined with a linear amplifier chain. The receiver amplified and purified signals from a non-resonant antenna. In other words, an increased multiple bit length was traded off with acceptance of some limited filter resonance to get sufficient filtering of the received signal. This combination allowed digital signal transmission of 800 kilobits per second in the lower 75 meter ham band and 1 mbit per second in the 30 meter ham band.

Co-pending patent application 63/640,237 describes the receiver. Generally, the receiver comprised two linear amplifier stages with 1 to 2 tuning circuits having adjustable resistance in the respective LC circuits to limit resonance-ringing of the received signal by lowering filter Q.

### Transmission Bandwidth

The signal input to the gate transistor of the output amplifier and amplified power signal at the output from this output transistor to an antenna were examined with a high-speed oscilloscope, but failed to reveal sidebands. A frequency scan, however, showed that side bands existed. These sidebands however could be reduced by a carrier signal comparison procedure as exemplified in Example 3. Most preferred is the selective quenching technique of Example 4.

### 10 MHz Transmission Results

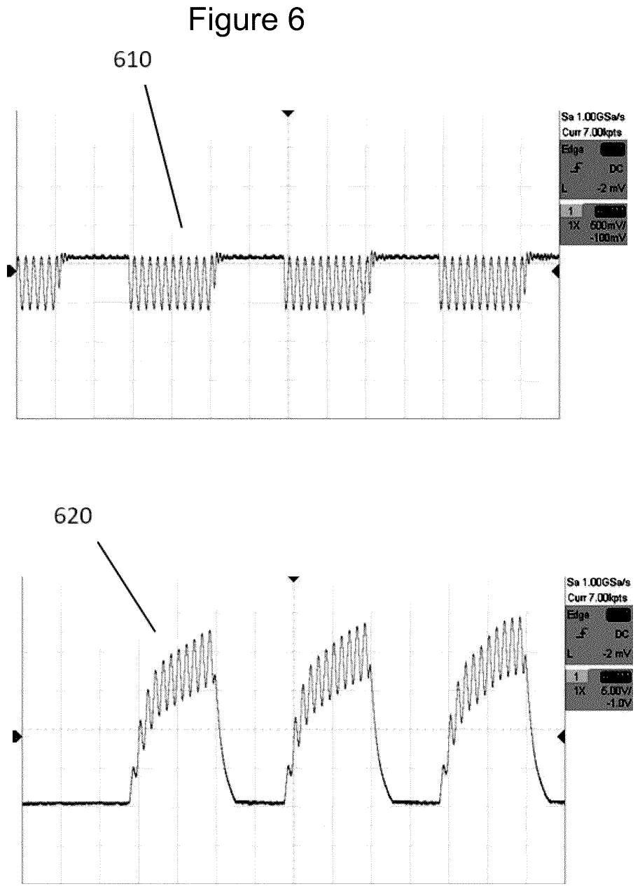

A 10 MHz sine wave and a synchronous 10 MHz square wave were input into the transmitter. The gate of the MOSFET was adjusted to 4.4 volts. The signal output at the gate, and the signal after amplification and sampling at the antenna connection are shown in the two figures, respectively of FIG. 6. The top scope plot of FIG. 6 shows signal 610 applied to the MOSFET gate. Signal 610 comprises 10 sine long alternating bit (1 and 0) signals of about 0.8 volts. The peaks of the waves are 100 ns apart along the x-axis. The y-axis shows relative signal strength. The bottom scope plot shows the resultant signal 620 at the antenna connection to the transmitter. Signal 620 comprises some distortion of the 10 sine long wave trains at the antenna, but each sine is clearly distinguishable. This distortion arises from some resonance and or inductive properties of the antenna, which were minimized by adjusting the antenna terminal resistor to ground to remove resonance.

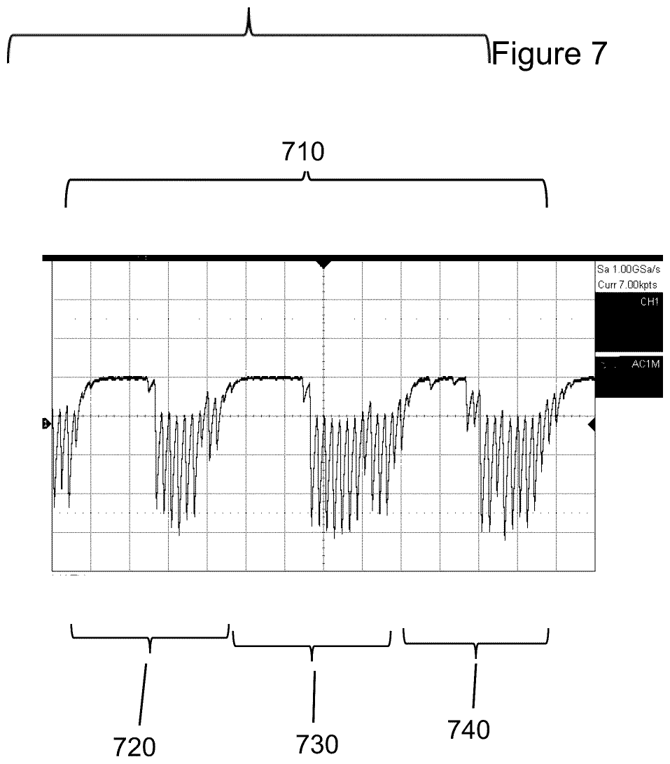

FIG. 7 shows a scope plot of the corresponding signal 710 recovered in the receiver. The X axis is time with major tick marks 500 nanoseconds apart. The Y axis is linear signal strength. The receiver was attached to a non-resonant TEFV antenna. The received signal underwent two stages of class A transistor amplification and one step of purification from a simple LC filter. As seen in this plot, the initial cycles of each train of signal 710 lost some energy to the filter, and each train of 10 cycles included a trailing end of a few cycles as expected due to the filter giving up stored energy to the circuit. The scope plot of signal 710 shows 3 complete 01 bit sequences 720, 730 and 740. The three successive 10 cycle long bits, which are separated by 10 cycle long blank periods are easily distinguishable. Each cycle=100 ns. This indicates that the 10 MHz transmitter with simple LC receiver system can communicate at 1 mbit per second.

### Example 2: Remove Harmonic Impurities Without Resonance Filtering of the Signal

To operate any kind of transmitter, the transmitted signal must be purified of its undesired harmonics. Passing the signal at one or more stages through one or more resonance filters is standard procedure in the radio art to remove harmonics. This is absolutely necessary in all existing commercial equipment. For amateur radio transmitters built recently, the FCC regulations require that any harmonics from a transmitted signal must be at least 43 db below the fundamental frequency transmitted.

The vast majority of the contaminating harmonic energy in the signal chain was found in the 2nd and 3rd harmonics. A digital technique of subtraction was discovered that can remove most of the energy in these harmonics and get their levels within range of the requirements, and without adding resonance. In this embodiment, a signal is sampled early in the transmitter at least before the last power output stage. One or more harmonics are purified out of the sampled signal and then amplified. The amplified harmonic(s) are then added back 180 degrees out of phase with the harmonics in the signal downstream from where it was sampled, but before the reference sine wave train is chopped to incorporate bit information.

In a preferred embodiment a reference signal to be amplified is sampled after one or more stages of amplification. One or more harmonics are purified out and added back by subtraction or addition of their inverse phase, and the amount of energy added back is established by sensing the harmonic contamination after the last stage, preferably at the antenna connection itself. This allows correction of contaminating harmonics by removing their effect before their creation because the correction signal to remove the contamination (i.e. negative harmonic) is added before generation of the harmonic contamination. This means that at some stages of the transmitter, the signal includes a small amount of harmonic contamination energy that is 180 degrees out of phase with the normal contaminating harmonic. Because the fundamental frequency itself is what causes the harmonic this advance cure of to-be-generated harmonic contamination works.

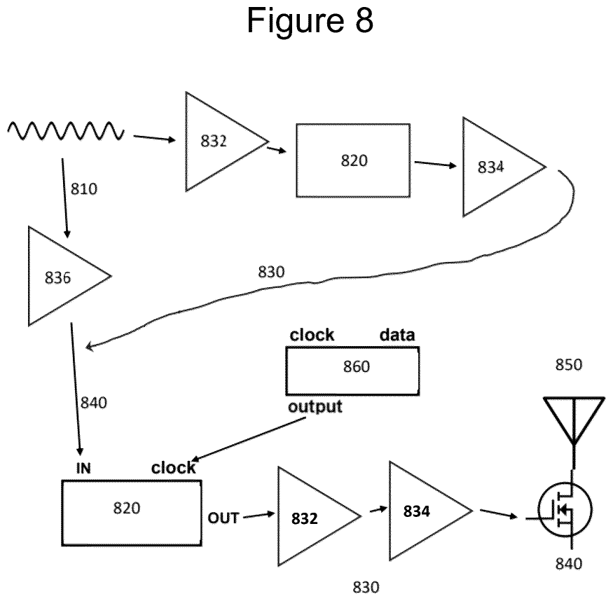

In an embodiment, and as depicted in the block diagram of FIG. 8, a reference signal 810 is sampled early in the signal chain, before being modified into short digital segments via fast analog switch 820. This modified signal is then amplified by current amplifiers 830, voltage amplifier 840, and sent to antenna 850 as described previously by FIG. 3.

In an embodiment harmonic contaminants are removed by sampling reference signal 810 at an early stage. The sample is passed through harmonic filter 820, which selects out either the 2nd or the 3rd harmonic. A controlled amount of the selected harmonic is added back via path 830 as an inverse waveform to form signal 840 before chopping into data bits. This allowed removal of harmonics, including harmonics generated at late stages in the transmitter signal path. Amplifiers 832 and 834 buffer and isolate signal 810 from the harmonic to prevent their interaction. Preferably amplifier 836 isolates the sampled reference signal from the composite amended signal 840. Flip flop 860 handles data flow as described previously.

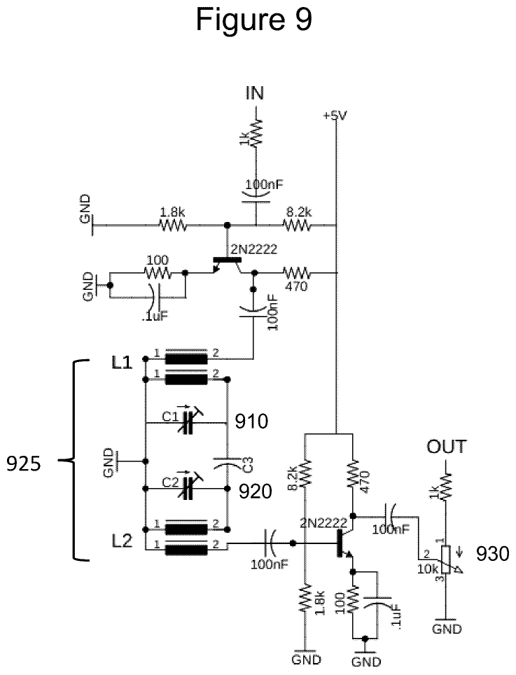

The harmonic filter in this embodiment is a bandpass type with a variable capacitor for tuning. The filtered signal is amplified and added back to the regular signal 810 to form amended signal 840 before the amended signal is broken into digital segments. FIG. 9 is a more detailed circuit diagram of a representative bandpass filter. This filter design, and the listed values for inductor and capacitor were taken from qrp-labs. See https://qrp-labs.com/images/bpfkit/bpf3.pdf.

The two variable tuning capacitors 910 and 920 of 4 element bandpass filter 925 shown on the left side of FIG. 9 were adjusted to phase shift the generated harmonic 180 degrees out of phase with the harmonic signal that contaminates the signal chain. Potentiometer 930 on the lower right side of FIG. 9 adjusted the correction signal strength by setting the amount of out of phase harmonic energy added back to the signal chain. This return of out-of-phase harmonics to the sine wave signal occurred before selection of individual bit segments with the square wave.

Phase adjust capacitors 910 and 920, and the signal strength potentiometer 930 were adjusted to minimize harmonics that were sensed at the point of antenna attachment. A Fourier math function of an oscilloscope was used to measure the ratio of harmonic to fundamental energy while making these adjustments with continuous (unbroken) carrier test signals. These controls were adjusted to minimize the ratio of the harmonic to the fundamental as seen on the scope. This is best done at 100% duty cycle (sine signal is 100% on with no blank periods). This allows compensation (removal) of harmonic distortion that occurs at all stages of the amplifier by adding the inverse of the second harmonic at the beginning of the amplifier chain while detecting purity of the result after all amplification steps.

A second bandpass filter likewise can sample and amplify the 3rd harmonic, and also subtract this from the sine signal chain. With proper attention to class A amplifier design, the higher 4th, 5th etc. harmonics do not need further purification and thus two harmonic filter-subtract circuits can be used to get the needed output signal purity.

In practice, a small amount of filtering may be needed to clean the signal. If the amplifiers biases are adjusted well and set for low power such as less than 5 watts, this transmitter was found to transmit acceptable harmonics quality signal without any control of the harmonics. In an embodiment a small amount of resonance, by virtue of feeding the signal to a resonant antenna, or by adding an LC filter before the antenna is used to further purify the transmitted signal. The latter is useful particularly when sending short bit segments of up to 5, 10, 25, 100 or even longer sine cycles per bit at a time but cannot be done when transmitting only a single sine per bit signal.

This technique, using the circuit of FIG. 9 was applied to a 8 MHz second harmonic of a 4 MHz signal, and decreased the second harmonic from 35 db below the fundamental to 43 db below the fundamental.

### Example 3: Removal of Sidebands While Avoiding Resonance Smearing of the Digital Carrier Signal

The digital carrier technique encodes information into the carrier and does not use side bands for communication. To remove side bands, most art suggests using resonating filters. It was discovered that such filters destroy the carrier signal integrity, even when their pass bands or cut off frequencies are far away from the carrier frequency. This prevented use of regular filters to remove sidebands.

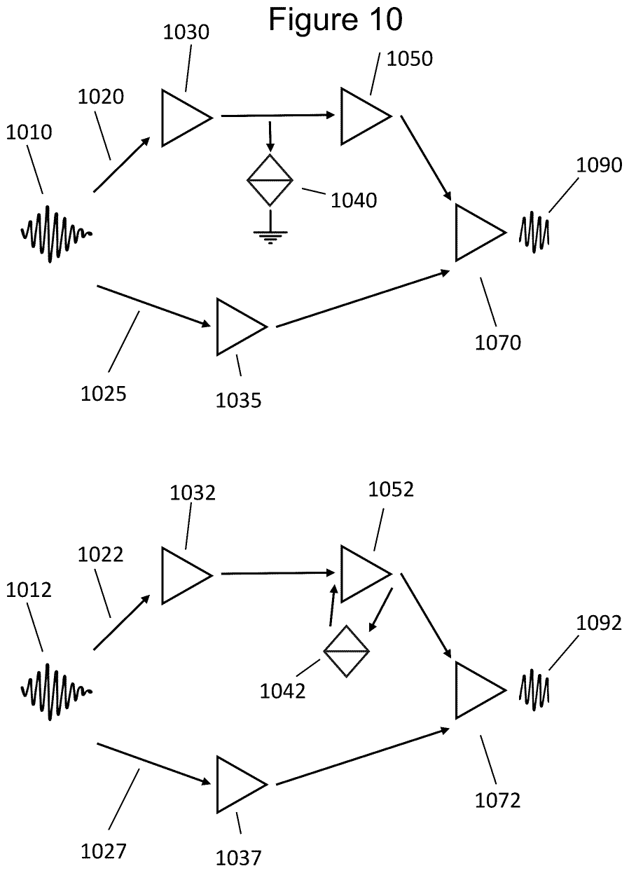

An indirect subtraction technique was discovered that removes sideband energy without destroying the carrier integrity. Two embodiments are shown in FIG. 10.

The top half of FIG. 10 is a block diagram that shows input signal 1010 comprising a strong carrier with strong, wide sidebands. Input signal 1010 enters two paths. In upper path 1020, the input signal is amplified by amplifier 1030, which outputs a buffered signal to amplifier 1050. This buffered output signal is exposed by electrical connection to crystal 1040, which removes some resonant energy from the carrier frequency portion of the signal that passes to amplifier 1050. Crystal 1040 depletes some of the carrier frequency, leaving a sideband enriched signal available to amplifier 1050. Amplifier 1050 then passes the buffered, diminished carrier signal from upper path 1020 to signal comparator 1070.

Meanwhile, signal 1010 also enters lower path 1025 and is amplified by amplifier 1035. Amplifier 1035 passes its buffered signal from lower path 1025 to signal comparator 1070. Signal comparator 1070 compares the two pathway generated signals and outputs a carrier enriched (sideband depleted) signal 1090. In this embodiment signal comparator 1070 subtracts the upper path signal from the lower path signal.

The upper signal path creates a carrier diminished signal in the same phase as original signal 1010 because each amplifier 1030 and 1050 inverts the signal 180 degrees. However, the lower signal path 1025 inverts the original signal 1010 only once by 180 degrees via amplifier 1035. When these are added together, the common wave patterns cancel out.

The bottom half of FIG. 10 is a block diagram that also removes sidebands by inverse addition to the signal after removal of carrier energy with help of crystal 1042. As in the top half, input signal 1012 comprises the same strong carrier with strong, wide sidebands.

Input signal 1012 enters two paths. In upper path 1022, the input signal is amplified by amplifier 1032, which outputs a buffered signal to amplifier 1052. Crystal 1042 is connected in negative feedback in amplifier 1052. In the embodiment of an inverting transistor amplifier (such as common emitter configuration), the crystal is connected between the collector and emitter (or drain and gate) which creates negative feedback at the crystal resonant frequency. This selectively decreases amplification of the carrier by amplifier 1052. Amplifier 1052 then passes the diminished carrier signal from upper path 1022 to signal comparator 1072. In a preferred embodiment an additional, non-inverting amplifier such as a voltage follower is inserted between amplifier 1052 and signal comparator 1072 to buffer the signal.

The lower path of this lower block diagram is the same as in the top block diagram. Signal 1012 enters lower path 1027, is amplified by amplifier 1035 and passes on to signal comparator 1072, which subtracts the upper path signal from the lower path signal.

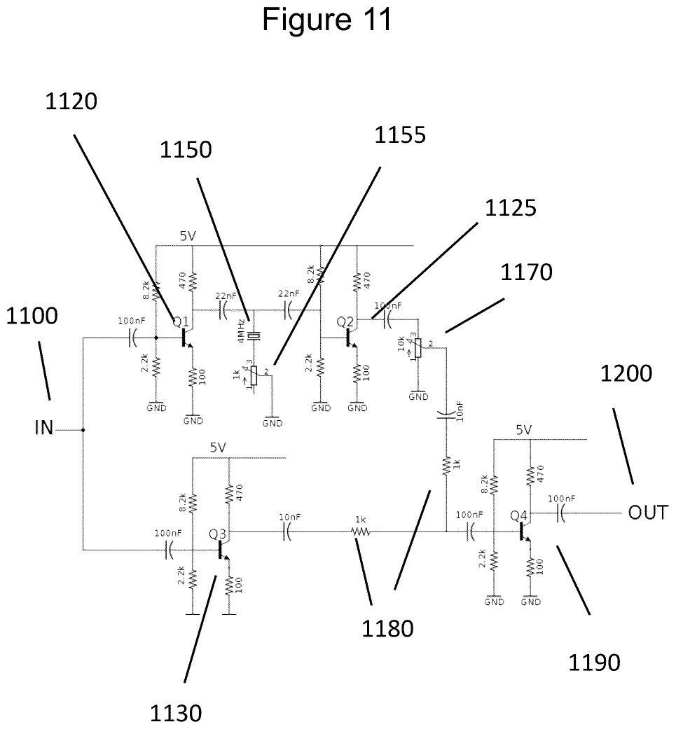

FIG. 11 shows a circuit embodiment of the FIG. 10 top half block diagram.

This circuit accepts digital carrier signal 1110, creates 2 identical paths for the signal by feeding into linear amplifiers 1120 and 1130, respectively, and outputs a carrier purified signal 1200. The top path linear amplifier 1120 output is exposed to crystal 1150, with attached damping resistor 1155, which deletes carrier frequency energy. This sideband purified signal then is buffered by linear amplifier 1125.

The sideband purified signal from linear amplifier 1125 is adjusted by resistor 1170 to equalize the signal strengths of sideband signal in the two paths to allow them to cancel out. Signals from both pathways enter amplifier 1190 via summing resistors 1180. The top amplifiers 1120 and 1125 invert the signal twice while the bottom path amplifier 1130 inverts the signal once. This allows them to subtract from each other.

Damping resistor 1155 is adjusted to decrease resonance, preferably to below critical damping where the crystal does not continue to oscillate without energy input. In a preferred embodiment a differential amplifier replaces amplifier 1190 and compares the two signals from amplifier 1130 and 1125 to output an enriched carrier signal. Other ways to remove the carrier in the upper path can be determined by a skilled user, for example with a controlled resonance LC circuit in place of the crystal. Two or more sideband removal circuits may be employed in time series. Each of the amplifiers in this example was an MMBT3904 NPN transistor biased for common emitter linear operation.

An important consideration of this technique is to get the phases of the two signals 180 degrees apart. It was found that adding even one transistor extra in the upper pathway limited the purification power due to about 10 ns difference in phase. In an embodiment, transistors in a longer path have a higher frequency response than transistor(s) in the shorter path. Preferably the gain x bandwidth product of one or more long path transistors is at least twice the gain x bandwidth product of one or more transistors in the shorter path. The higher frequency response transistors pass signals faster than lower frequency response transistors. A skilled artisan can equalize the transit time by selecting and testing alternative transistor combinations. Although this was not a big problem at 4 MHz, such difference must be considered at higher frequencies. In an embodiment a small inductor of about 0.1 to 5 nanohenries is added to the short path to help ameliorate this problem.

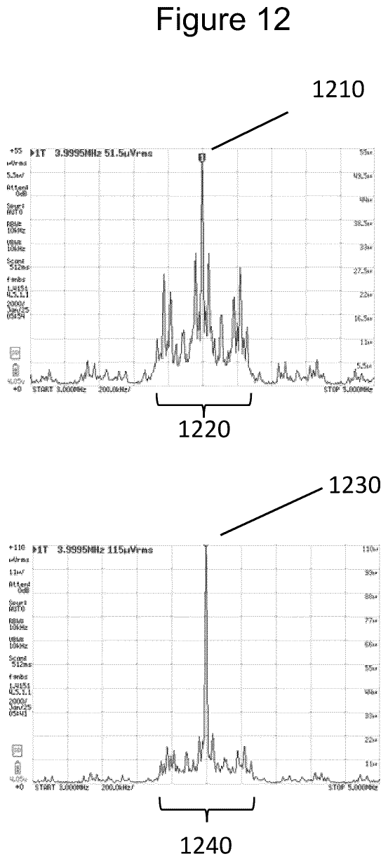

FIG. 12 shows spectrum analyzer data obtained from operating the circuit of FIG. 11. The digital carrier signal was at 3.9996 MHz and a 4 MHz crystal was used. The digital carrier signal had to be lowered by 400 hertz because the crystal vibrated (minimum reactance) at 3.9996 MHz and the effective passband (roll off) sensitivity bandwidth of crystal operation was about 200 hertz, even when operated with the damping resistor above 400 ohms. The digital carrier signal comprised 10 sine segments (1 bit) interspersed with 10 sine wave long pauses (a 0 bit) between them in a random pattern.

The spectrum analyzer outputs shown here are scans taken between 3 MHz and 5 MHz. Each vertical bar on the display represents 200 khz frequency separation.

The top plot 1201 shows a scan from a spectrum analyzer of the unfiltered signal. The bottom plot 1291 is a scan after filtration with resistor 1155 adjusted to 400 ohms, which was deemed optimum.

Top plot 1201 shows the digital carrier 1210 at 3.9995 MHz. Much energy was in the broad sidebands signal 1220 between 3.7 MHz and 4.3 MHz. Bottom plot 1291 shows the same digital carrier 1230 at 3.9995 MHz and a greatly diminished sidebands signal 1240.

Several 4.000 MHz crystals were compared and all exhibited sharp resonance peaks even with the damping resistance. The carrier frequency had to be adjusted within a narrow region of about 3.9996 MHz to 3.9997 MHz. The filtering resulted in a bandpass of about 200 Hz, which allows broadcast of narrow bandwidth filtered digital carrier signals. Bandwidths less than 500 Hz and even less than 200 Hz are achievable with this technique if temperature compensation were used to correct frequency drift.

Wider filter bandpasses may be needed to accommodate multiple closely spaced signals. In an embodiment two or more crystals are connected in parallel to broaden the bandpass up to 500 Hz, 1 kHz or even more, in either the transmitter, receiver, or both. The term bandwidth as used here is known to experts in radio. This can be measured as the −3 db power point on either side of the carrier frequency.

### Example 4: Removal of Sidebands via selective Quenching With an Inverter-resonator

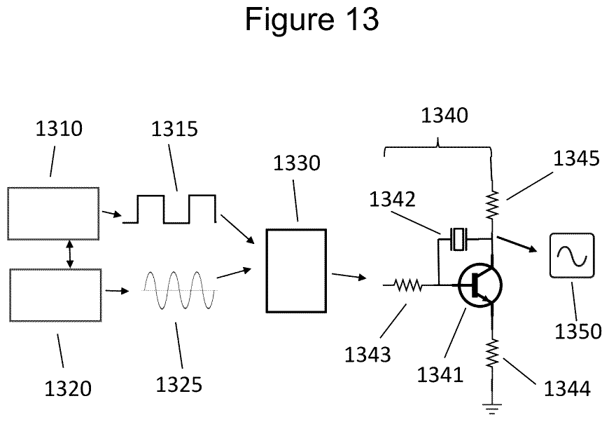

It was discovered that a resonator such as a crystal used in its parallel resonance mode and connected in a negative feedback portion of an inverting amplifier could selectively remove sidebands. This works particularly well with transistor amplifier circuits that invert the amplified signal. FIG. 13 is a diagram of an example that uses the apparatus described above to create a digital carrier with sidebands. This complex signal is applied to an inverting amplifier such as a common emitter or common source transistor amplifier. A crystal is chosen having a nominal resonant frequency just below the digital carrier frequency to be filtered.

This technique is useful for any application or circuit where it is desired to purify a narrow band signal away from nearby signals. Except for the crystal, preferably resonance is otherwise absent in the circuit. That is, a signal is input to the inverting amplifier and taken out of the inverting amplifier without any resonance at the connections. It was found that use of a traditional interstage coupling, impedance coupler, or resonating filter in combination with this inverting amplifier failed to work due to excessive resonation of the crystal. Preferably the input and output connections to the inverting amplifier such as shown in FIG. 13 lack resonance and preferably have series resistance of between 100 and 1000 ohms resistance or higher.

FIG. 13 shows inverting circuit 1340 based on transistor 1341. Sine reference 1310 creates the carrier signal, which is manipulated by circuit 1330. In this example) circuit 1330 uses a synchronous square wave 1320 to create 0 and 1 bits in the carrier. The output of manipulation circuit 1330 is a digital (interrupted) carrier with side bands. This sideband rich signal enters inverted amplifier circuit 1340 via resistor 1343. Transistor 1341 preferably is biased for an amplification ratio of at least 10 and preferably at least 50. Base bias is not shown and emitter (or source) resistor 1344 preferably is bypassed with a capacitor as is customary. The inverted, amplified signal 1350 is taken from the collector to resistor 1345 junction in this case. A skilled artisan can adapt virtually any inverting amplifier to replace amplifier 1340 as long as extraneous resonance sources are not connected so as to influence the resonator 1342. Other parallel resonance sources such as a parallel connected inductor and capacitor, selected to have equal resonances at the transmitter frequency can be used for selective quenching. The “resonator” in this embodiment does not swing into resonance with the carrier frequency but instead allows negative feedback for signals on either side of the carrier frequency, while having minimum action on the carrier.

In an embodiment two crystals are used in parallel to widen the bandpass of the selective quenching and in another embodiment two selective quenching filters are used in series to improve removal of sidebands.

This sideband filter was made with a 4.000 MHz crystal and successfully decreased sidebands at least 10 fold, and typically 100 fold as seen from a spectrum analyzer of the input signal and output signals. The 4 MHz crystal parallel resonance peak was at 4.001 MHz and the degree of purification was controlled by changing the transmitter frequency over a 500 hertz range. In practice, filter tuning was carried out by changing this frequency. Adding capacitance (up to 50 pF) in series or in parallel with an AT cut crystal is useful for optimizing this circuit for a given frequency.

The techniques and principles explored in this study apply to all communications at all wavelengths. This project focused on simple on/off manipulation of a sine wave signal in the lower ham band frequencies of 2-21 MHz. These results point the way to a much higher photon pulse transmission rate for faster communication at narrow bandwidths.

A wide variety of antennas, reference signal generation techniques and frequencies are intended for use in embodiments. For example, a small non-resonant rhombic antenna is preferred for transmission at frequencies above 400 MHZ.

Although embodiments of the invention have been described in detail above with reference to the drawings, a specific configuration is not limited to the embodiments, and designs and the like that do not depart from the essential spirit of the invention also fall within the claims.

1. A digital carrier transmitter comprising:
a frequency generator;
an input that accepts a digital message to transmit;
a non-resonant antenna; and
a circuit connected to the frequency generator that receives the digital message from the input, generates individual sine wave pulses having one or more sine wave lengths with sine wavelength determined from the frequency generator, and outputs sine wave pulses to the antenna in a direct current.

2. The digital carrier transmitter of claim 1, further comprising a zero-crossing detector that detects zero crossing time of the reference frequency and switches an output transmitted signal at zero crossing.

3. The digital carrier transmitter of claim 1, wherein the circuit lacks resonance.

4. The digital carrier transmitter of claim 1, further comprising a sideband removal circuit that enriches sine wave pulses of the digital carrier frequency without using a resonating filter to absorb the sidebands.

5. The digital carrier transmitter of claim 4, wherein the sideband removal circuit produces a signal for transmission having a bandwidth less than 200 Hz.

6. The digital carrier transmitter of claim 1, wherein the transmitter lacks a transmission line.

7. A direct current radio transmitter that transmits each data bit as less than 20 sine wave long duration discrete pauses, or pulses of electromagnetic energy, comprising:
a radio signal generator having a frequency output;
a non-resonant antenna; and
a circuit that accepts the frequency output and generates discrete integer length wavelength portions or discrete half integer length wavelength portions of the wavelength of the radio signal reference as direct current to the non-resonant antenna.

8. The direct current radio transmitter of claim 7, further comprising:
a data input that accepts bit data and wherein the bit data triggers a circuit to select the integer copies or half copies of the wavelength of the radio signal reference that is output as direct current to the non-resonant antenna.

9. The direct current radio transmitter of claim 7, wherein the transmitter lacks resonant filters with Q values above 10 to remove harmonics or sidebands in a signal to be broadcast.

10. The digital carrier transmitter of claim 7, further comprising a sideband removal circuit that enriches the sine wave pulses for the digital carrier.

11. The digital carrier transmitter of claim 10, wherein the sideband removal circuit produces a signal for transmission having a bandwidth less than 500 Hz.

12. The digital carrier transmitter of claim 7, wherein the transmitter lacks a transmission line.

13. A digital carrier radio transmitter comprising:
a radiofrequency signal;
at least one linear amplifier that amplifies the radio frequency signal and outputs a direct current to a connected non-resonant antenna;
a zero-crossing detector that selects an integral number or halves of sine waves from the radiofrequency signal; and
the non-resonant antenna receives direct current in the form of pulses of the selected integral number or halves of sine waves.

14. The digital carrier radio transmitter of claim 13 wherein the radio transmitter transmits two signals simultaneously that are 180 degrees out of phase with each other.

15. The digital carrier radio transmitter of claim 13, further comprising a harmonic suppressor circuit, the harmonic suppressor circuit comprising:
a harmonic filter that purifies a harmonic of the radiofrequency signal to create a harmonic enriched signal and
a differential amplifier or summing circuit that compares the harmonic enriched signal with the radiofrequency signal, and produces a comparison signal having reduced harmonic energy than the radiofrequency signal.

16. The digital carrier transmitter of claim 13, further comprising a sideband removal circuit that enriches the sine wave pulses for the digital carrier frequency by selective quenching of sidebands with an inverting amplifier that contains negative feedback for the sidebands.

17. The digital carrier transmitter of claim 16, wherein the sideband removal circuit purifies the sine wave pulses of the digital carrier frequency with a bandwidth less than 500 Hz.

18. The digital carrier transmitter of claim 13, wherein the transmitter lacks a transmission line.

19. The digital carrier transmitter of claim 13, wherein the transmitter transmits less than 20 sine wave long duration discrete pulses of electromagnetic energy for each bit of signal information.

20. The digital carrier transmitter of claim 1, wherein a DC power supply is electrically connected to the transmitter, the connection provides a zero voltage at the transmitter output to the antenna and a plus voltage to ground, and wherein the power supply energizes direct current electron energy movement into the antenna from the transmitter.
